(19) United States
(12) Patent Application Publication
(10) Pub. No.: US 2017/0284733 A1
(43) Pub. Date: Oct. 5, 2017

(54) REMOTE FOOD MANAGEMENT SYSTEM

(71) Applicant: TECO Electric & Machinery Co., Ltd., Taipei City (TW)

(72) Inventors: Chwen-Jy CHIU, Taipei City (TW); Yen-Han HU, Taipei City (TW)

(21) Appl. No.: 15/084,072

(22) Filed: Mar. 29, 2016

(51) Int. Cl. F25D 29/00; G06K 9/32; G08B 5/22; G06T 7/40

(52) U.S. Cl. CPC F25D 29/003; G06T 7/408; G06K 9/3241; G08B 5/223; G06K 2209/17; G06T 2207/30128; F25D 2700/06; F25D 2500/06; F25D 2400/361

(57) ABSTRACT

A remote food management system includes a smart refrigerator, a food ingredients identification device and a smart phone. The smart refrigerator is used for storing at least one food ingredient. The food-ingredient identifying device is used for capturing a food-ingredient image with respect to the food ingredient. The circuit module analyzes the food-ingredient image to produce a plurality of food-ingredient information and at least one freshness parameter, and further calculates an expiration date for the food ingredient. Then, the circuit module establishes a list of food ingredients according to the expiration date. The smart phone is connected to the food-ingredient identifying device so as to read and show the list.

### BACKGROUND OF INVENTION

1. Field of the Invention

The invention relates to a remote food management system, and more particularly to the remote food management system that uses food-ingredient images to analyze names of food ingredients and the corresponding expiration dates.

2. Description of the Prior Art

Recently, due to the popularity of smart phones, ordinary electric appliances for daily life have been gradually replaced by the smart appliances capable of coupling the smart phones. Thus, the smart appliance can be remotely controlled by the user through networking. For example, the smart phone is usually applied to remotely control domestic monitors, air conditioners, lamps and the like appliances. Further, the manufacturers have developed smart refrigerators with camera modules, such that users can use directly smart phones to monitor storage statuses of their own smart refrigerators.

As stated above, though the current smart refrigerator may provide interior images of the smart refrigerator, yet the user can't judge if the food ingredients currently inside the smart refrigerator are out of dates or not. Actually, in this circumstance, the user can only depend on his/her own memory to determine if the food ingredients inside the refrigerator are out of dates or not. However, in the case that the food ingredients are stored into the refrigerator by some other people, then the judgment would be definitely difficult from these images.

### SUMMARY OF THE INVENTION

In view of the prior art as mentioned above, it is understood that the current smart refrigerator can simple provide its interior images to user's smart phone, and it is hard for the user to judge if the food ingredients inside the refrigerator are out of dates or not. Actually, from these interior images, the user can only tell types and amounts of the food ingredients. Accordingly, it is the primary object of the present invention to provide a remote food management system that can use the captured food-ingredient images to realize effective storage limits of the food ingredients, so that the food ingredients inside the smart refrigerator can be efficiently managed, and misuse of the outdated food ingredients can be completely avoided.

In the present invention, the remote food management system includes a smart refrigerator, a food-ingredient identifying device and a smart phone. The smart refrigerator storing at least one food ingredient. The food-ingredient identifying device located inside the smart refrigerator further includes an image-capturing lens and a circuit module. The image-capturing lens for capturing an image of the at least one food ingredient so as to generate at least one food-ingredient image.

The circuit module electrically coupled with the image-capturing lens for receiving the food-ingredient image further includes an analysis unit, a food-ingredient database, a processing unit, a storage unit and a transmission module. The analysis unit analyzes the food-ingredient image to further generate a plurality of food-ingredient information and at least one freshness parameters with respect to the food ingredient. The food-ingredient database builds in a plurality of basic food-ingredient information and a plurality of image reference information with respect to the plurality of basic food-ingredient information.

The processing unit electrically coupled with the analysis unit and the food-ingredient database realizes the plurality of food-ingredient information and the plurality of image reference information to further judge specific basic food-ingredient information from the plurality of basic food-ingredient information that account to the at least one food ingredient so as to base on the specific basic food-ingredient information and the freshness parameters to calculate an effective storage limit for the food ingredient. The processing unit further bases on the specific basic food-ingredient information and the effective storage limit to establishing a list of food ingredients. The storage unit electrically coupled with the processing unit is to store the list of food ingredients. The transmission module is electrically coupled with the storage unit.

The smart phone connects communicatively the transmission module so as to read and then display the list of food ingredients via the transmission module.

Compared to the conventional smart refrigerator as described in the background section that can simply provide the smart phone smart the interior image of the smart refrigerator, the remote food management system of the present invention can provide not only the storage of the food ingredients inside the smart refrigerator, but also the expiration date of the specific food ingredient. Thereupon, the user can manage the food ingredients inside the smart refrigerator more effectively and conveniently.

In one embodiment of the present invention, the freshness parameters at least include one of glossiness, color brightness and color uniformity.

In one embodiment of the present invention, the plurality of food-ingredient information at least includes a contour shape and a food-ingredient color, the processing unit analyzing the contour shape, the food-ingredient color and the plurality of food-ingredient image reference information to determine the basic food-ingredient information corresponding to the food ingredient. Preferably, the plurality of food-ingredient information further includes an estimated food-ingredient volume, the processing unit basing on the estimated food-ingredient volume and a reference food-ingredient density of the plurality of food-ingredient image reference information to generate a food-ingredient weight corresponding to the food ingredient.

In one embodiment of the present invention, the circuit module further includes a clock unit electrically coupled with the processing unit to provide an instant time, the processing unit basing on the instant time and the effective storage limit to generate an expiration date.

In one embodiment of the present invention, the storage unit further pre-stores a plurality of recipe information, and the smart phone provides recipe options. While a specific one of the recipe options is clicked, at least one of the recipe information is displayed. Preferably, the recipe options include a search recipe option, an existing recipe option or a food-ingredient recipe option. The search recipe option is to search and then display at least one of the plurality of recipe information. The existing recipe option is to display at least one existing recipe information of the plurality of recipe information, which the existing recipe information contains required food ingredients including the at least one food ingredient. The food-ingredient recipe option is to display the required food ingredients of the plurality of recipe information that includes at least one food ingredient.

In one embodiment of the present invention, the circuit module further includes a bar code-identifying unit electrically coupled with the processing unit for identifying a bar-code label of the food-ingredient image so as to further obtain provider's food-ingredient supply information.

All these objects are achieved by the remote food management system described below.

### BRIEF DESCRIPTION OF THE DRAWINGS

The present invention will now be specified with reference to its preferred embodiment illustrated in the drawings, in which:

FIG. 1 is a schematic view of the preferred remote food management system in accordance with the present invention;

FIG. 2 is a schematic view of a display showing options of a smart phone in accordance with the present invention;

FIG. 3 is a schematic view of a display on the smart phone showing a list of food ingredients in accordance with the present invention;

FIG. 4 is a schematic view of a display on the smart phone showing options of recipes in accordance with the present invention;

FIG. 5 is a schematic view of a display on the smart phone showing a result after clicking the option of recipe search in FIG. 4;

FIG. 6 is a schematic view of a display on the smart phone showing a result after clicking the option of existing recipes in FIG. 4; and

FIG. 7 is a schematic view of a display on the smart phone showing a result after clicking the option of food-ingredient recipes in FIG. 4.

### DESCRIPTION OF THE PREFERRED EMBODIMENT

The invention disclosed herein is directed to a remote food management system. In the following description, numerous details are set forth in order to provide a thorough understanding of the present invention. It will be appreciated by one skilled in the art that variations of these specific details are possible while still achieving the results of the present invention. In other instance, well-known components are not described in detail in order not to unnecessarily obscure the present invention.

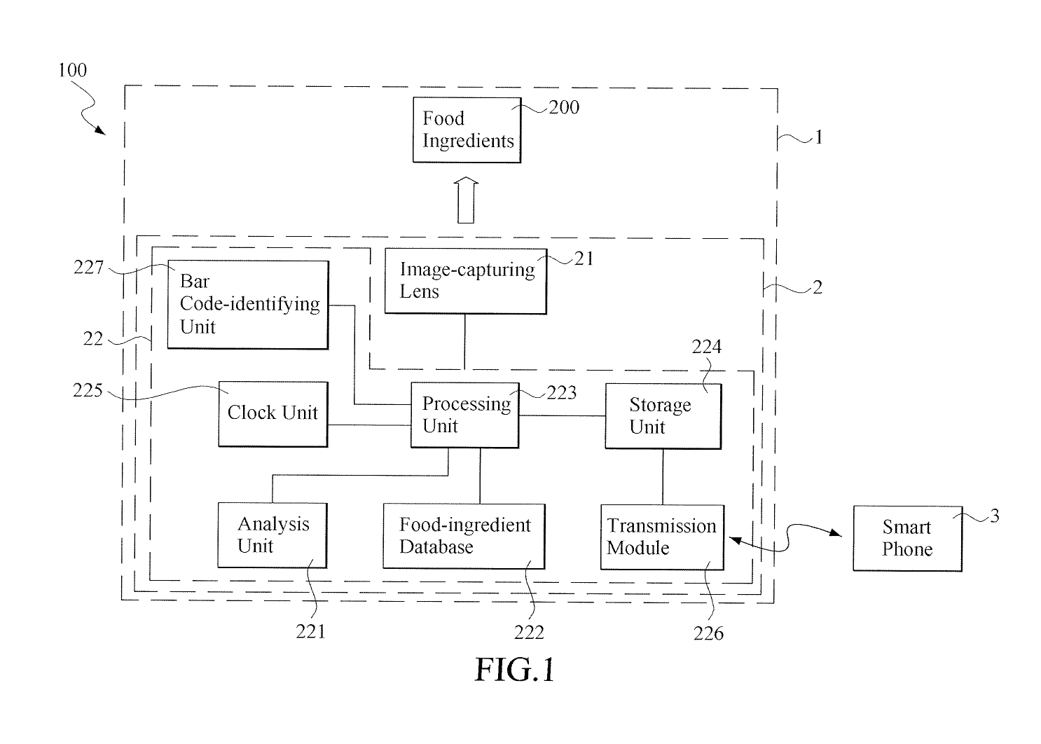

Referring now to FIG. 1, a schematic view of the preferred remote food management system in accordance with the present invention is shown. The remote food management system 100 includes a smart refrigerator 1, a food-ingredient identifying device 2 and a smart phone 3.

The smart refrigerator 1 stores at least one food ingredient 200. The food-ingredient identifying device 2 located inside the smart refrigerator 1 includes an image-capturing lens 21 and a circuit module 22. The image-capturing lens 21 performs image-capturing upon the one food ingredient 200 inside the smart refrigerator 1 so as further to generate a corresponding food-ingredient image.

The circuit module 22 electrically coupled with the image-capturing lens 21 for receiving the food-ingredient image includes an analysis unit 221, a food-ingredient database 222, a processing unit 223, a storage unit 224, a clock unit 225, a transmission module 226 and a bar code-identifying unit 227.

The analysis unit 221 analyzes the food-ingredient image so as further to generate three food-ingredient information and three freshness parameters corresponding to the food ingredient 200. The three food-ingredient information include a contour shape, a food-ingredient color and an estimated food-ingredient volume. The three freshness parameters include glossiness, color brightness and color uniformity. For example, in this embodiment, the food ingredient 200 can be a cattle tomato with an elliptic contour shape, a red food-ingredient color, an estimated food-ingredient volume of 400 cm³, the glossiness of 70 GU (Gloss unit), the color brightness of 6, and the uniform color uniformity.

The food-ingredient database 222 builds in a plurality of basic food-ingredient information and a plurality of image reference information corresponding to the plurality of basic food-ingredient information. The basic food-ingredient information includes a name of the food ingredient and a food-ingredient density corresponding to the name of the food ingredient. The image reference information includes a standard food-ingredient contour shape, a standard food-ingredient color, a standard food-ingredient effective storage limit, standard food-ingredient glossiness, standard food-ingredient brightness and standard food-ingredient color uniformity with respect to the name of the food ingredient. In this embodiment, the basic food-ingredient information includes names and corresponding densities of various meats, vegetables, fruits and other food ingredients. By having the cattle tomato as a typical example, then the name of food ingredient would be “cattle tomato”, the density is 1.1 g/cm³, the standard food-ingredient contour shape is a quasi-elliptic shape, the color is red, the glossiness is 75GU, the color brightness is 7, and the color uniformity is extremely uniform.

The processing unit 223 electrically coupled with [symbol] the analysis unit 221 and the food-ingredient database 222 analyzes the food-ingredient information and the image reference information so as to determine a specific basic food-ingredient information with respect to the food ingredient 200. According to the specific basic food-ingredient information and the corresponding freshness parameters, the processing unit 223 can calculate an effective storage limit with respect to the food ingredient. The processing unit 223 further bases on the basic food-ingredient information and the effective storage limit to establish a list of food ingredients. In this embodiment, the processing unit 223 compares the contour shape and the food-ingredient color with respect to the food ingredient 200 so as to determine a standard food-ingredient contour shape and a standard food-ingredient color that meet the cattle tomato. Hence, the food ingredient 200 can be determined as a cattle tomato. Further, the processing unit 223 compares the freshness parameters to the standard food-ingredient glossiness, the standard food-ingredient brightness and the standard food-ingredient color uniformity in the image reference information, and the comparison results show that these data are extremely close. Thus, it can be concluded that the food ingredient 200 is pretty fresh, and also an expiration date is assigned. For example, the standard effective storage limit for the cattle tomato is usually a 10-day period. Since the processing unit 223 judges that the cattle tomato is extremely fresh, thus the assigned expiration date would be 10 days.

As described above, since the food ingredient 200 in this example is the cattle tomato, thus the processing unit 223 can directly calculate the number of the cattle tomatoes by using the food-ingredient information. However, in some other embodiments, as the food ingredient 200 is a food ingredient without a constant contour shape such as a meat and the like, the processing unit 223 can then base on the estimated food-ingredient volume and the reference food-ingredient density to calculate and then generate a corresponding food-ingredient weight.

The storage unit 224 electrically coupled with the processing unit 223 is to store a list of food ingredients, and also to pre-store a plurality of recipe information.

The clock unit 225 electrically coupled with the processing unit 223 is to provide an instant time. The processing unit 223 can base on the instant time and the standard effective storage limit to generate an estimated expiration date. In the aforesaid example, if the instant time is December 5^{th}, then the estimated expiration date would be on the December 15^{th}; namely, a day by adding the effective storage limit to the instant time.

The transmission module 226 is electrically coupled with the storage unit 224. In practical applications, the transmission module 226 can be a network connection port, a 3G module, a Bluetooth module or a WiFi module.

The bar code-identifying unit 227 electrically coupled with the processing unit 223 is to identify a bar-code label at the food-ingredient image so as to obtain a provider's food-ingredient supply information. In this example, the food ingredient 200 is actually a food ingredient with a bar-code label. However, in some other embodiments, the food ingredient 200 may have a bar-code label on the packaging material of the food ingredient 200, so that the bar code-identifying unit 227 can judge the bar-code label to obtain provider's food-ingredient supply information.

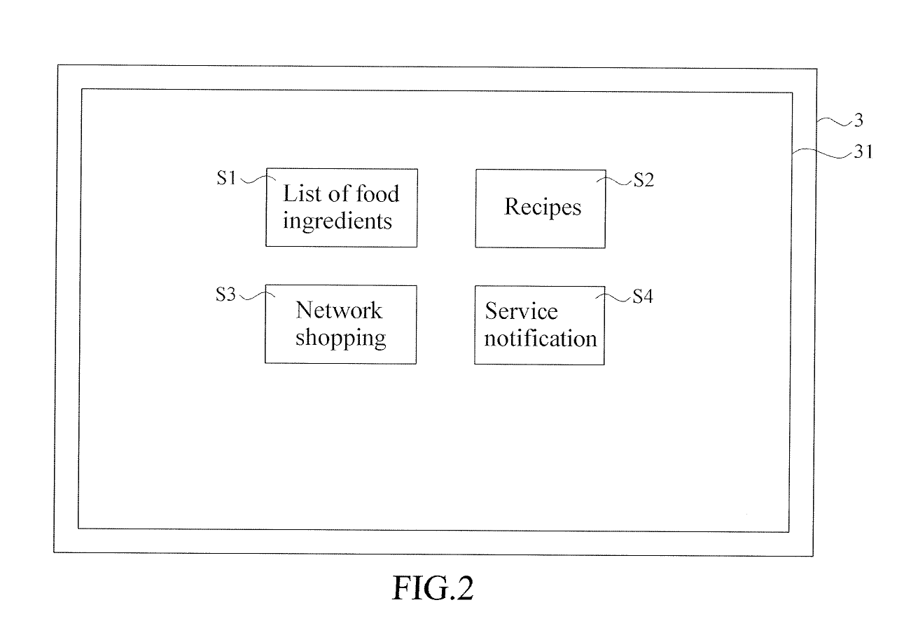

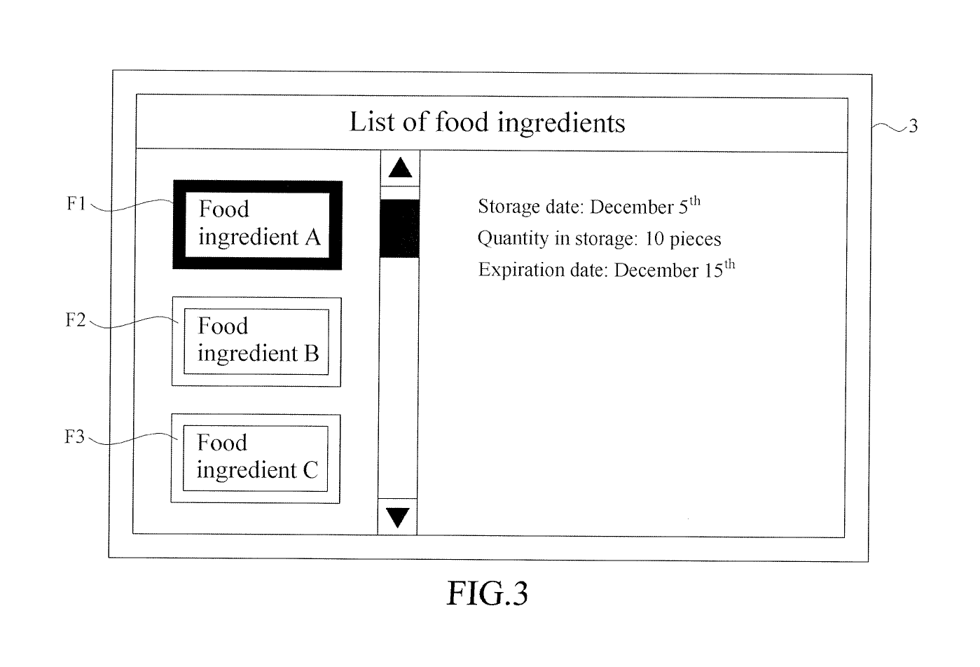

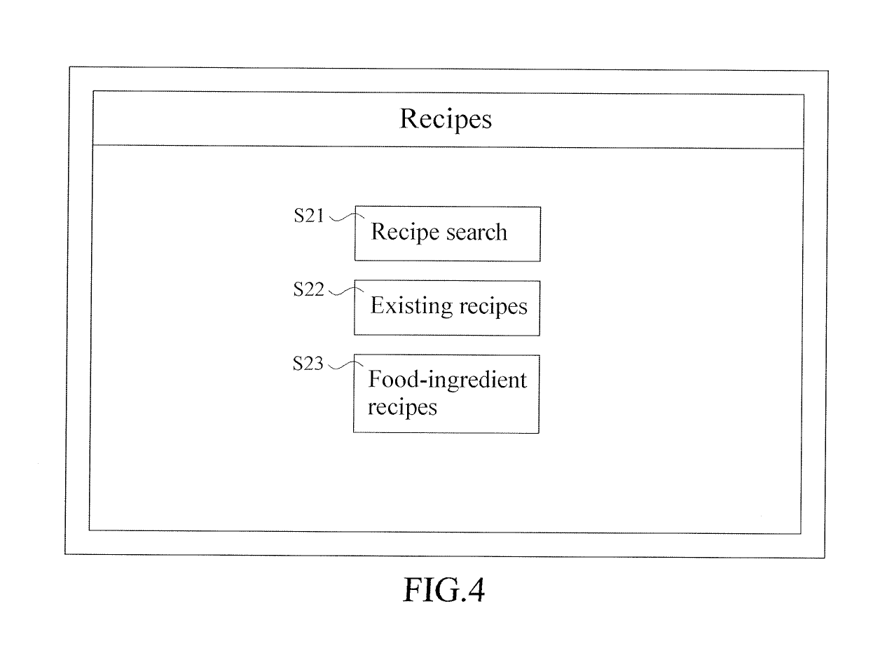

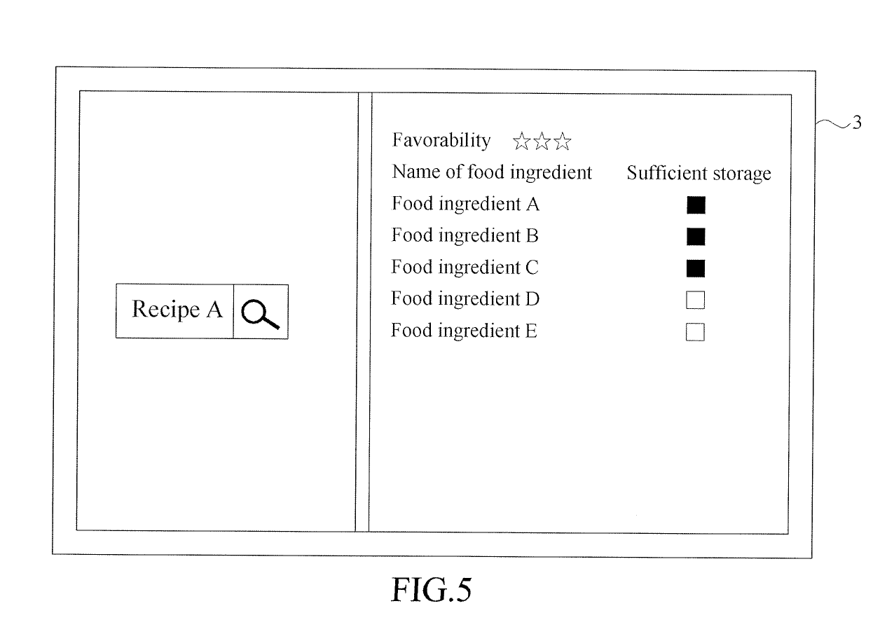

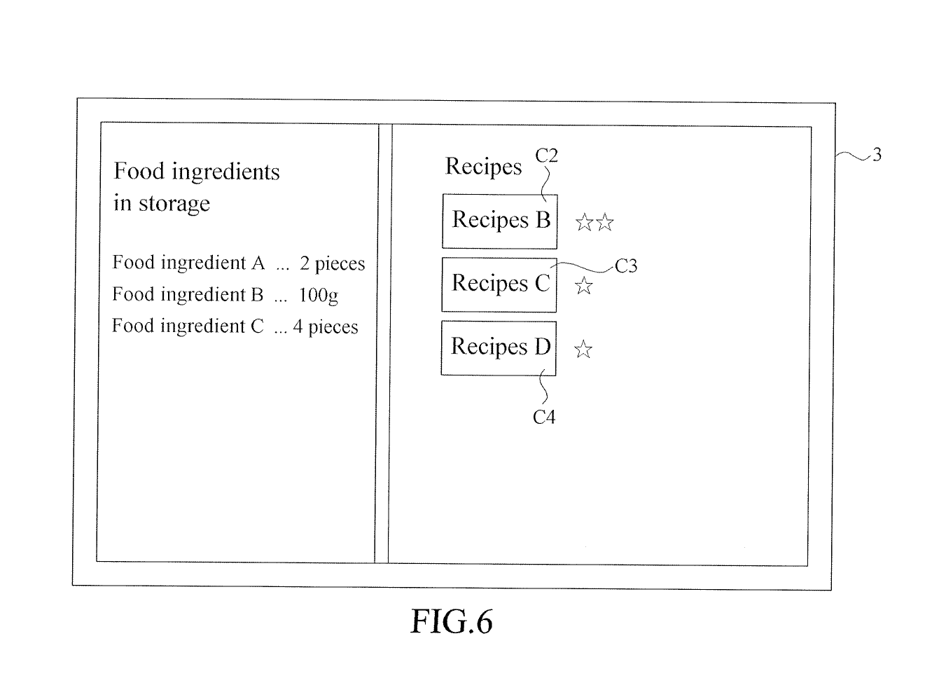

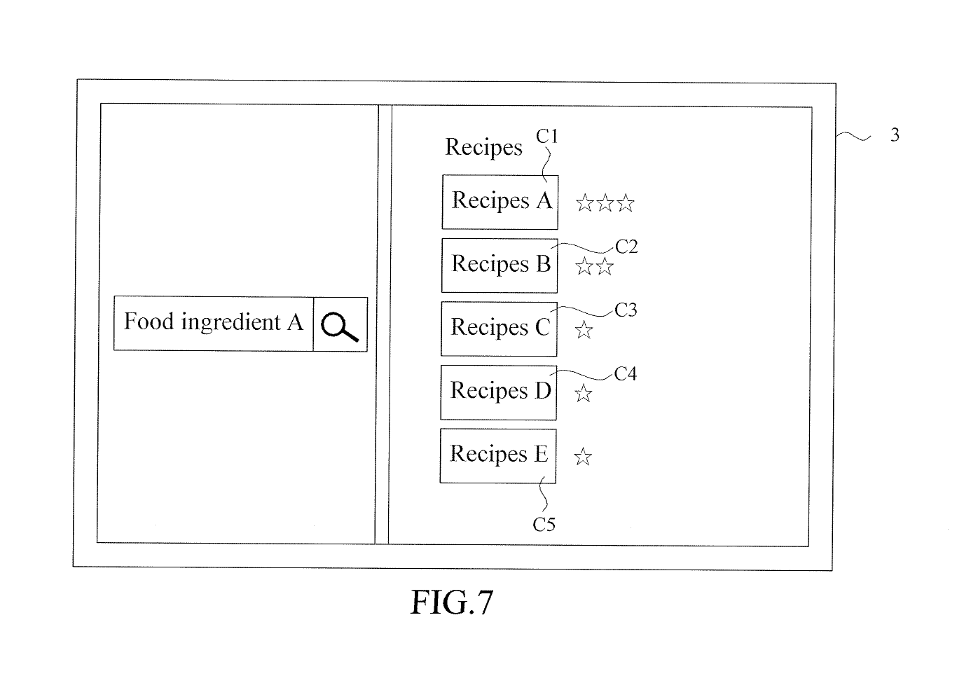

Refer now to FIG. 1 through FIG. 7; where FIG. 2 is a schematic view of a display showing options of a smart phone in accordance with the present invention, FIG. 3 is a schematic view of a display on the smart phone showing a list of food ingredients in accordance with the present invention, FIG. 4 is a schematic view of a display on the smart phone showing options of recipes in accordance with the present invention, FIG. 5 is a schematic view of a display on the smart phone showing a result after clicking the option of recipe search in FIG. 4, FIG. 6 is a schematic view of a display on the smart phone showing a result after clicking the option of existing recipes in FIG. 4, and FIG. 7 is a schematic view of a display on the smart phone showing a result after clicking the option of food-ingredient recipes in FIG. 4.

As shown, the smart phone 3 connecting communicatively to the transmission module 226 is to provide a list of food-ingredient options S1, recipe options S2, network shopping options S3 and service-informing options S4, in which the smart phone 3 can be a smart phone or a tablet computer.

As a user clicks a list of food-ingredient options S1, the smart phone 3 would apply the transmission module 226 to read the list of food ingredients, and to display the list of food ingredients, as shown in FIG. 3. The list of food ingredients shows a food ingredient A (option F1), a food-ingredient B (option F2) and a food ingredient C (option F3), and, at the right-hand-side column, the food-ingredient information for the clicked food ingredient A (option F1) is displayed.

When a touch area defining the “recipe options” S2 is clicked, the smart phone 3 would further display a search recipe option S21, an existing recipe option S22 and a food-ingredient recipe option S23. The search recipe option S21 is to receive a keyword or keywords input from a user so as to trigger a corresponding search upon the recipe information, and the search result from the recipe information would be displayed on the smart phone 3. In this embodiment, if the search is based on the keyword “recipe A” for example, then the food ingredients A·E in the recipe A would then be displayed. Simultaneously, a comparison between the food ingredients in the list of food ingredients and the food ingredients of the recipe A would be carried out to see the correlation in between. In addition, while in displaying the recipe A, a corresponding favorability of the recipe A (calculated by evaluating the usage frequency) would be displayed as well.

When a touch area defining the existing recipe option S22 is clicked, the smart phone 3 would display an amount of the storage food ingredients and the recipe information if the required food ingredients in the recipe information are met by the storage food ingredients. Namely, this display includes the information showing if the required food ingredients in the recipe information can be part of the food ingredients contained in the list of food ingredients.

When a touch area defining the food-ingredient recipe option S23 is clicked, the smart phone 3 would display the required food ingredients of the recipe information that include the input food ingredient. In this example, the input food ingredient is the food ingredient A, and the food ingredient A can be used to prepare the recipes A, B, C, D and E. Hence, the smart phone 3 would display a recipe A (option C2), a recipe B (option C2), a recipe C (option C3), a recipe D (option C4) and a recipe E (option C5). While the recipe information is displayed, user's favorability would be displayed as well, and the display arrangement of the recipe information is usually based on the user's favorability. In addition, when any of the recipe A (option C1), the recipe B (option C2), the recipe C (option C3), the recipe D (option C4) and the recipe E (option C5) is clicked, then the smart phone 3 would display the corresponding recipe information.

The “network shopping options” S3 is provided for the user to perform online shopping of the food ingredients via the smart phone 3.

The “service-informing options” S4 is to inform the manufacturer to perform maintenance while any problem between the smart phone 3 and the smart refrigerator 1 is met.

As described above, the remote food management system of the present invention can apply the image-capturing lens of the food-ingredient identifying device to capture a food-ingredient image upon a food ingredient inside the smart refrigerator, and apply the circuit module to realize the basic food-ingredient information and the effective storage limit of the food ingredient. The smart phone would display the basic food-ingredient information and the expiration date for the user to precisely manage the food ingredients inside the smart refrigerator. In addition, the circuit module can further use the instant time provided by the clock unit to calculate the expiration date of the food ingredient. Further, since the circuit module can pre-store the recipe information, so the smart phone can then display the list of food ingredients and the recipe information according to various needs.

Compared to the conventional smart refrigerator as described in the background section that can simply provide the smart phone smart the interior image of the smart refrigerator, the remote food management system of the present invention can provide not only the storage of the food ingredients inside the smart refrigerator, but also the expiration date of the specific food ingredient. Thereupon, the user can manage the food ingredients inside the smart refrigerator more effectively and conveniently.

In addition, when the food ingredients are cooked and then stored in the smart refrigerator, the food-ingredient identifying device can also record these cooked food ingredients and calculate other parameters such as the storage time, the favorability and the like. Further, in some specific applications, the processing unit can further include an alert unit for issuing an alert signal to the smart phone while the food ingredient is approaching its own expiration date, such that the user can be inform the urgent state of the food ingredient.

While the present invention has been particularly shown and described with reference to a preferred embodiment, it will be understood by those skilled in the art that various changes in form and detail may be without departing from the spirit and scope of the present invention.

What is claimed is:

1. A remote food management system, comprising:
a smart refrigerator, storing at least one food ingredient; and
a food-ingredient identifying device, located inside the smart refrigerator, further including:
an image-capturing lens, for capturing an image of the at least one food ingredient so as to generate at least one food-ingredient image; and
a circuit module, electrically coupled with the image-capturing lens, being to receive the at least one food-ingredient image, further including:
an analysis unit, analyzing the at least one food-ingredient image to generate a plurality of food-ingredient information and at least one freshness parameter with respect to the at least one food ingredient;
a food-ingredient database, building in a plurality of basic food-ingredient information and a plurality of image reference information with respect to the plurality of basic food-ingredient information;
a processing unit, electrically coupled with the analysis unit and the food-ingredient database, realizing the plurality of food-ingredient information and the plurality of image reference information to further judge specific basic food-ingredient information from the plurality of basic food-ingredient information that account to the at least one food ingredient so as to base on the specific basic food-ingredient information and the freshness parameters to calculate an effective storage limit for the food ingredient, the processing unit further basing on the specific basic food-ingredient information and the effective storage limit to establishing a list of food ingredients;
a storage unit, electrically coupled with the processing unit, being to store the list of food ingredients, further pre-storing a plurality of recipe information; and
a transmission module, electrically coupled with the storage unit; and
a smart phone, connecting communicatively the transmission module so as to read the list of food ingredients via the transmission module, being to display the list of food ingredients, providing recipe options, displaying at least one of the plurality of recipe information corresponding to one of the recipe options that is clicked.

2. The remote food management system of claim 1, wherein the freshness parameters at least include one of glossiness, color brightness and color uniformity.

3. The remote food management system of claim 1, wherein the plurality of food-ingredient information at least includes a contour shape and a food-ingredient color, the processing unit analyzing the contour shape, the food-ingredient color and the plurality of food-ingredient image reference information to determine the basic food-ingredient information corresponding to the food ingredient.

4. The remote food management system of claim 3, wherein the plurality of food-ingredient information further includes an estimated food-ingredient volume, the processing unit basing on the estimated food-ingredient volume and a reference food-ingredient density of the plurality of food-ingredient image reference information to generate a food-ingredient weight corresponding to the food ingredient.

5. The remote food management system of claim 1, wherein the circuit module further includes a clock unit electrically coupled with the processing unit to provide an instant time, the processing unit basing on the instant time and the effective storage limit to generate an expiration date.

6. The remote food management system of claim 1, wherein the recipe options include a search recipe option for searching and then displaying at least one of the plurality of recipe information.

7. The remote food management system of claim 1, wherein the recipe options include an existing recipe option for displaying at least one existing recipe information of the plurality of recipe information, the existing recipe information containing required food ingredients including the at least one food ingredient.

8. The remote food management system of claim 1, wherein the recipe options include a food-ingredient recipe option for displaying required food ingredients of the plurality of recipe information that includes the at least one food ingredient.

9. The remote food management system of claim 1, wherein the circuit module further includes a bar code-identifying unit electrically coupled with the processing unit for identifying a bar-code label of the food-ingredient image so as to further obtain provider's food-ingredient supply information.
